(19) United States
(12) Patent Application Publication
(10) Pub. No.: US 2001/0034298 A1
(43) Pub. Date: Oct. 25, 2001

(54) CATALYST FOR POLYMERIZATION OF ETHYLENE AND METHOD FOR PRODUCING ETHYLENE POLYMERS

(76) Inventors: EIJI ISOBE, YOKOHAMA-SHI (JP); TOSHIHIKO SUGANO, YOKKAICHI-SHI (JP); KAORI IMAEDA, YOKKAICHI-SHI (JP); YUMITO UEHARA, TOKYO (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/181,607

(22) Filed: Oct. 28, 1998

(51) Int. Cl. B01J 31/00; C08F 10/00

(52) U.S. Cl. 502/117; 502/103; 502/152; 502/155

(57) ABSTRACT

There is provided a catalyst for the polymerization of ethylene, comprising the following components [A] and [B] in combination:

[A] a metallocene type transition metal compound represented by the following formula [1] or [2]

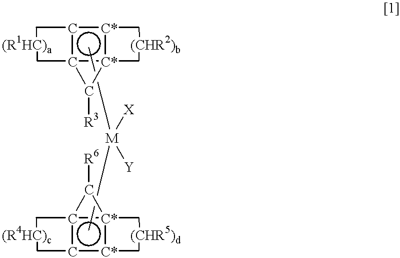

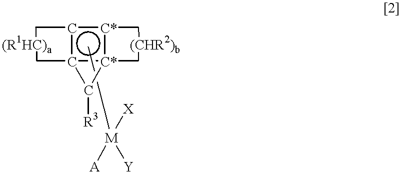

wherein, R¹, R², R³, R⁴, R⁵, and R⁶, which may be the same or different, each independently represent a hydrogen atom, a halogen atom, a hydrocarbon group having 1 to 20 carbon atoms, a halogen-containing hydrocarbon group having 1 to 20 carbon atoms, a silicon-containing hydrocarbon group, a nitrogen-containing hydrocarbon group, a phosphorus-containing hydrocarbon group, or a boron-containing hydrocarbon group, an alkoxy group, an aryl group, an aryloxy group, or an amino group; M represents a metal atom selected from group 4 to 6 elements of the periodic table; X and Y represent a hydrogen atom, a halogen atom, a hydrocarbon group, an alkoxy group, an amino group, an amido group, a phosphorus-containing hydrocarbon group, or a silicon-containing hydrocarbon group; A represents a ligand selected from a cyclopentadienyl group, a substituted cyclopentadienyl group, an indenyl group, a substituted indenyl group, a fluorenyl group, a substituted fluorenyl group, an azulenyl group, and a substituted azulenyl group; a and c are an integer of 2 to 10; and b and d are an integer of 0 to 10, provided that, if b or d is 0, carbon atoms represented by C* are each independently linked to a hydrogen atom, a halogen atom, or to a hydrocarbon group having 1 to 20 carbon atoms, a halogen-containing hydrocarbon group, a silicon-containing hydrocarbon group, a nitrogen-containing hydrocarbon group, a phosphorus-containing hydrocarbon group, a boron-containing hydrocarbon group, an alkoxy group, an aryl group, or an aryloxy group, provided that atoms or groups linked to the respective carbon atoms may be the same or different; and

[B] the following compound (a), (b), (c), or (d)

(a) an aluminumoxy compound,

(b) a Lewis acid,

(c) an ionic compound which can be reacted with the component [A] to convert the component [A] to a cation, or

(d) an ion-exchangeable layered inorganic compound.

### BACKGROUND OF THE INVENTION

1. Field of the Invention

The present invention relates to a catalyst for the polymerization of ethylene, and a process for polymerizing ethylene in the presence of the catalyst. More particularly, the present invention relates to a catalyst for the polymerization of ethylene which can be applied to conventional processes for the polymerization of olefins, such as solution polymerization, high pressure polymerization, slurry polymerization, and gas phase polymerization, particularly preferably to slurry polymerzation and gas phase polymerization, can produce an ethylene polymer having high molecular weight, and does not cause the evolution of a significant amount of hydrogen at the time of polymerization, and a process for polymerizing ethylene in the presence of the catalyst.

2. Background Art

Use of catalyst systems comprising (1) metallocenes and (2) aluminoxanes in the polymerization of an olefin in the presence of a polymerization catalyst to produce an olefin polymer has already been proposed (Japanese Patent Laid-Open No, 35007/1985, Japanese Patent Publication No. 12283/1992 and the like)

Polymerization in the presence of these catalyst systems is advantageous over polymerization in the presence of conventional Ziegler-Natta catalysts comprising titanium compounds or vanadium compounds and organoaluminium compounds in that the polymerization activity per transition metal is higher and, in addition, olefin polymers having narrower molecular weight distribution and composition distribution can be obtained.

In this case, however, use of a large amount of aluminoxanes is necessary to obtain, using these catalysts, polymerization activity high enough for commercial production of polymers, and, hence, the polymerization activity per aluminum is low. This is disadvantageously cost-ineffective. Further, the residue of the catalyst should be removed from the resultant polymer.

On the other hand, a proposal has been made on a process for polymerizing an olefin in the presence of a catalyst system comprising one of or both a metallocene compound and an aluminoxane supported on an inorganic oxide, such as silica or alumina (Japanese Patent Laid-Open Nos. 108610/1986, 135408/1985, 296008/1986, 74412/1991, and 74415/1991 and the like). Further, a proposal has been made on a process for polymerizing an olefin in the presence of a catalyst system comprising one of or both a metallocene compound and an organoaluminium supported on an inorganic oxide, such as silica or alumina, or an organic material (Japanese Patent Laid-Open Nos. 101303/1989, 207303/1989, 234709/1991, and 50869/1991).

In these processes, however, the polymerization activity per aluminum is still unsatisfactory, and the content of the residual catalyst in the resultant olefin polymer is not negligible. In order to solve these problems, a catalyst has been proposed which comprises an ion-exchangeable layered compound, an organoaluminium, and a metallocene compound (Japanese Patent Laid-Open No. 295022/1993 and the like).

Although these catalysts can provide satisfactorily high polymerization activity per transition metal or aluminum contained in the metallocene compound, they suffer from a problem that hydrogen is evolved as a by-product at the time of the polymerization and the hydrogen makes it difficult to increase the molecular weight of the ethylene polymer. This has led to a demand for an improvement in the catalyst. Regarding catalyst components capable of providing high-molecular weight olefin polymers, metallocene compounds having a ligand comprising indenyl or tetrahydroindenyl which has been substituted at its 2-position have been described as useful for the polymerization of propylene (Japanese Patent Laid-Open No. 59772/1996). In general, however, the amount of hydrogen evolved as the by-product in the polymerization of propylene is smaller than that in the case of the polymerization of ethylene. Therefore, it is quite unknown whether or not use of catalyst components, effective for the polymerization of propylene, in the polymerization of ethylene can provide high-molecular weight ethylene polymers. The mechanism of evolution of hydrogen in the polymerization of ethylene has not been fully elucidated yet. In this connection, however, a σ-bond metathesis mechanism has been proposed from an aspect of calculation chemistry (T. K. Woo, L. Fan, and T. Ziegler, Organometallics, Vol. 13, p. 2252 (1994) and the like). According to this mechanism, inhibition of σ-coordination of an olefin to the central metal of the metallocene compound is considered effective in inhibiting tie evolution of hydrogen as the by-product

Minimizing the concentration of hydrogen in the polymerization reaction system is important in obtaining a high-molecular weight ethylene polymer under such a condition as will evolve hydrogen as the by-product. In the prior art, however, the operation of the polymer used is very difficult and unstable. In some cases, in order to obtain an ethylene polymer having contemplated molecular weight, a special measure should be taken such as the provision of an apparatus for removing hydrogen evolved as the by-product. This is very disadvantageous from the viewpoint of competition on cost and the like. Therefore, an improvement in the prior art techniques has been strongly desired in the art,

### SUMMARY OF THE INVENTION

It is an object of the present invention to solve the above problems of the prior art and to provide a catalyst for the polymerization of ethylene which does not cause the evolution of a significant amount of hydrogen as the by-product at the time of polymerization and can provide a high-molecular weight ethylene polymer with high polymerization activity, and a process for producing an ethylene polymer in the presence of the catalyst.

According to the present invention, the above object can be attained by a catalyst for the polymerization of ethylene, comprising the following components [A] and [B] in combination:

[A] a metallocene type transition metal compound represented by the following formula [1 or 2]

wherein R¹, R², R³, R⁴, R⁵, and R⁶, which may be the same or different, each independently represent a hydrogen atom, a halogen atom, a hydrocarbon group having 1 to 20 carbon atoms, a halogen-containing hydrocarbon group, a silicon-containing hydrocarbon group, a nitrogen-containing hydrocarbon group, a phosphorus-containing hydrocarbon group, or a boron-containing hydrocarbon group, an alkoxy group, an aryl group, or an aryloxy group; M represents a metal atom selected from group 4 to 6 elements of the periodic table; X and Z present a hydrogen atom, a halogen atom, a hydrocarbon group, alkoxy group, an amino group, an amido group, a phosphorus-containing hydrocarbon group, or a silicon-containing hydrocarbon group; A represents a ligand selected from a cyclopentadienyl group, a substituted cyclopentadienyl group, an indenyl group, a substituted indenyl group, a fluorenyl group, a substituted fluorenyl group, an azulenyl group, and a substituted azulenyl group; a and c are an integer of 2 to 10; and b and d are an integer of 0 to 10, provided that, if b or d is 0, carbon atoms represented by C* are each independently linked to a hydrogen atom, a halogen atom, or to a hydrocarbon group having 1 to 20 carbon atoms, a halogen-containing hydrocarbon group, a silicon-containing hydrocarbon group, a nitrogen-containing hydrocarbon group, a phosphorus-containing hydrocarbon group, a boron-containing hydrocarbon group, an alkoxy group, an aryl group, or an aryloxy group, provided that atoms or groups linked to the respective carbon atoms may be the same or different; and

[B] the following compound (a), (b), (c), or (d)

(a) an aluminumoxy compound,

(b) a Lewis acid,

(c) an ionic compound which can be reacted with the component [A] to convert the component [A] to a cation, or

(d) an ion-exchangeable layered inorganic compound.

### DETAILED DESCRIPTION OF THE INVENTION

The component [A] constituting the catalyst of the present invention is a metallocene type transition metal compound represented by the formula [1] or [2wherein R¹, R², R³ R⁴, R⁵, and R⁶₁ which may be the same or different, each independently represent a hydrogen atom, a halogen atom, a hydrocarbon group having 1 to 20 carbon atoms, a halogen-containing hydrocarbon, a silicon-containing hydrocarbon group, a nitrogen-containing hydrocarbon group, a phosphorus-containing hydrocarbon group, or a boron-containing hydrocarbon group, an alkoxy group, an aryl group, or an aryloxy group; M represents a metal atom selected from group 4 to 6 elements of the periodic table; X and Z represent a hydrogen atom, a halogen atom, a hydrocarbon group, an alkoxy group, an amino group, a phosphorus-containing hydrocarbon group, or a silicon-containing hydrocarbon group; A represents a ligand selected from a cyclopentadienyl group, a substituted cyclopentadienyl group, an indenyl group, a substituted indenyl group, a fluorenyl group, a substituted fluorenyl group, an azulenyl group, and a substituted azulenyl group; a and c are an integer of 2 to 10; and b and d are an integer of 0 to 10, provided that, if b or d is 0, carbon atoms represented by C* are each independently linked to a hydrogen atom, a halogen atom, or to a hydrocarbon group having 1 to 20 carbon atoms, a halogen-containing hydrocarbon group, a silicon-containing hydrocarbon group, a nitrogen-containing hydrocarbon group, a phosphorus-containing hydrocarbon group, a boron-containing hydrocarbon group, an alkoxy group, an aryl group, or an aryloxy group, provided that atoms or groups linked to the respective carbon atoms may be the same or different.

In the general formulae [14 and [2], examples of substituents represented by R¹, R², R³, R⁴, R⁵, and R⁶ include a hydrogen atom and hydrocarbon groups having 1 to 20 carbon atoms, preferably 1 to 12 carbon atoms, and, in addition, halogen atoms, such as fluorine, chlorine, and bromine, and alkoxy groups having 1 to 12 carbon atoms, for example, silicon-containing hydrocarbon groups having 1 to 24 carbon atoms represented by —Si(R⁷)(R)(R9), phosphorus-containing hydrocarbon groups having 1 to 18 carbon atoms represented by —P(R⁷)(R⁸), nitrogen-containing hydrocarbon groups having 1 to 18 carbon atoms represented by —N(R⁷)(R⁸), and boron-containing hydrocarbon groups having 1 to 18 carbon atoms represented by —B(R⁷)(R⁸). When there are a plurality of substituents, these substituents may be the same or different. R⁷ to R⁹, which may be the same or different, represent a hydrogen atom or an alkyl group having 1 to 20 carbon atoms.

a and c are an integer of 2 to 10, and b and d are an integer of 0 to 10. Preferably, a and c are an integer of 3 to 8, and b and d are an integer of 0 to 8. When b or d is 0, examples of substituents of the carbon atom represented by C* include a hydrogen atom and hydrocarbon groups having 1 to 20 carbon atoms, preferably 1 to 12 carbon atoms, and, in addition, halogen atoms, such as fluorine, chlorine, and bromine, and alkoxy groups having 1 to 12 carbon atoms, for example, silicon-containing hydrocarbon groups having 1 to 24 carbon atoms represented by —Si(R⁷)(R⁸)(R⁹), phosphorus-containing hydrocarbon groups having 1 to 18 carbon atoms represented by —P(R⁷)(R⁸), nitrogen-containing hydrocarbon groups having 1 to 18 carbon atoms represented by —N(R⁷)(R⁸), and boron-containing hydrocarbon groups having 1 to 18 carbon atoms represented by —B(R⁷)(R⁸). when there are a plurality of substituents, these substituents may be the me or different. R⁷ to R⁹, which may be the same or different, represent a hydrogen atom or an 1 group having 1 to 20 carbon atoms.

M represents a metal atom selected from group 4 to 6 elements of the periodic table, preferably a group 4 metal atom of the periodic table. Specific examples thereof include titanium, zirconium, and hafnium. Among them, zirconium and hafnium are particularly preferred.

X and Z each independently represent a hydrogen atom, a halogen atom, a hydrocarbon group having 1 to 20 carbon atoms, preferably I to 10 carbon atoms, an alkoxy group having 1 to 20 carbon atoms, preferably 1 to 10 carbon atoms, a nitrogen-containing hydrocarbon group having 1 to 20 carbon atoms, preferably 1 to 18 carbon atoms, a phosphorus-containing hydrocarbon group having 1 to 20 carbon atoms, preferably 1 to 12 carbon atoms, or a silicon-containing hydrocarbon group having 1 to 20 carbon atoms, preferably 1 to 12 carbon atoms, such as a trimethylsilyl or bis(trimethylsilyl)methyl group. X and Z may be the same or different. Among them, a halogen atom, a hydrocarbon group, particularly a hydrocarbon group having 1 to 8 carbon atoms, and an amino group are preferred.

A in the general formula [2] is selected from a cyclopentadienyl group, a substituted cyclopentadienyl group, a indenyl group, a substituted indenyl group, a fluorenyl group, a substituted fluorenyl group, an azulenyl group, and a substituted azulenyl group. Substituents in the substituted cyclopentadienyl group, the substituted indenyl group, the substituted fluorenyl group, and the substituted azulenyl group include, bur are not particularly limited to, hydrocarbon groups having 1 to 20 carbon atoms, preferably 1 to 12 carbon atoms, and, in addition, halogen atoms, such as fluorine, chlorine, and bromine, and alkoxy groups having 1 to 12 carbon atoms, for example, silicon-containing hydrocarbon groups having 1 to 24 carbon atoms represented by —Si(R⁷)(R⁸)(R⁹), phosphorus-containing hydrocarbon groups having 1 to 18 carbon atoms represented by —P(R⁷)(R⁸), nitrogen-containing hydrocarbon groups having 1 to 18 carbon atoms represented by —N(R⁷)(R⁸), and boron-containing hydrocarbon groups having 1 to 18 carbon atoms represented by —B(R⁷)(R⁸). When there are a plurality of substituents, these substituents may be the same or different. R⁷ to R⁹, which may be the same or different, represent a hydrogen atom or an alkyl group having 1 to 20 carbon atoms.

X and Y each independently represent a hydrogen atom, a halogen atom, a hydrocarbon group having 1 to 20 carbon atoms, preferably 1 to 10 carbon atoms, an alkoxy group having 1 to 20 carbon atoms, preferably 1 to 10 carbon atoms, a nitrogen-containing hydrocarbon group having 1 to 20 carbon atoms, preferably 1 to 18 carbon atoms, a phosphorus-containing hydrocarbon group having 1 to 20 carbon atoms, preferably 1 to 12 carbon atoms, or a silicon-containing hydrocarbon group having 1 to 20 carbon atoms, preferably 1 to 12 carbon atoms, such as a trimethylsilyl or bis(trimethylsilyl)methyl group. X and Y may be the same or different. Among them, a halogen atom, a hydrocarbon group, particularly a hydrocarbon group having 1 to 8 carbon atoms, and an amino group are preferred. In the catalyst for the polymerization of ethylene according to the present invention, among the compounds represented by the general formulae [1] and [2, those containing at least one of the following ligands are preferred as the component [A]:

tetrahydroindenyl derivatives, such as tetrahydroindenyl, 1 -methyltetrahydroindenyl, and 2-methyltetrahydroindenyl; isodicyclopentadienyl and isodicyclopentadienyl derivatives; octahydrobenzoindenyl and octahydrobenzoindenyl derivatives; octahydrofluorenyl and octahydrofluorenyl derivatives; and hexahydroazulenyl and hexabydroazulenyl derivatives. Among them, tetrahydroindenyl derivatives having a substituent at the 2-position, hexahydroazulenyl derivatives having a substituent at the 2-position, and octahydrofluorenyl derivatives having a substituent at the 2-position are especially preferred.

For A in the general formula [21, particularly preferred are the following groups:

cyclopentadienyl, methyl-cyclopentadienyl, 1,2-dimethylcyclopentadienyl, 1,3-dimethylcyclopentadienyl, n-butylcyclopentadienyl, indenyl, 2-methylindenyl, 2,4-dimethyhindenyl, 2-methyl-4-phenylindenyl, 2-methylbenzoindenyl, fluorenyl, 1-methylfluorenyl, 2-methyl-4H-azulenyl, 2,4-dimethyl-4H-azulenyl, and 2-methyl-4-phenyl-4H-azulenyl.

For M, X, and Z the compounds represented by the general formulae [1] and [2], particularly preferred are

M: group 4 transition metals; and

X and Z chlorine, a methyl group, and a diethylamino group.

The component [A] may also be a mixture of two or more compounds represented by either the general formula [1] or the general formula [2], or a mixture of at least one compound represented by one of the general formulae [1] and [2] and at least one compound represented by the other general formula.

Specific examples of transition metal compounds represented by the general formula [1] include

(1) bis(trihydropentalenyl)zirconium dichloride,

(2) bis(tetrahydroindenyl)zirconium dichloride,

(3) bis(2-methyltetrahydroindenyl)zirconium dichloride,

(4) bis(2-ethyltetrahydroindenyl)zirconium dichloride,

(5) bis(4-methyltetrahydroindenyl)zircornium dichloride,

( 6) bis(2,4-dimethyltetrahydroindenyl)zirconium dichloride,

(7) bis(2-methyl-4-phenyltetrahydroindnyl)zirconium dichloride,

(8) bis(hexhydroazulenyl)zirconium dichloride,

(9) bis(2-methylhexahydroazurenyl) zirconium dichloride,

(10) bis(2,4-dimethylhexahydroazulenyl)zirconium dichloride,

(11) bis(hexahydrocyclopentacyclooctenyl)zirconium dichloride,

(12) bis(octahydroyclopentacyclodecenyl)zirconium dichloride,

(13) bis(decahydrocyclopentacyclododecenyl)zirconium dichloride,

(14) bis(octahydrofluorenyl)zirconium dichloride,

(15) bis( 1-methyloctahydrofluorenyl)zirconium diehloride,

(16) bis(isodicyclopentadienyl)zirconium dichloride,

(17) bis(octahydrobenzoindenyl)zirconium dichloride,

(18) bis(tetrahydroindenyl)zirconium monochloride monohydride,

(19) bis(tetrahydroindenyl)methylzirconium monochloride,

(20) bis(tetrahydroindenyl)ethylzirconium monochloride,

(21) bis(tetrahydroindenyl)phenylzirconium monochloride,

(22) bis(tetrahydroindenyl)zirconium dimethyl,

(23) bis(tetrahydroindenyl)zirconium diphenyl,

(24) bis(tetrahydroindenyl)zirconium dineopentyl,

(25) bis(tetrahydroindenyl)zirconium dihydride,

(26) bis(octahydrofluorenyl)tetrahydroindenylzirconium dichloride, and

(27) (2-methyltetrahydroindenyl)tetrahydroindenylzirconium dichloride.

Specific examples of transition metal compounds represented by the general formula [2] include

(1) (trihydropentalenyl)cyclopentadienylzirconium dichloride,

(2) (tetrahydroindenyl)cyclopentadienyl-zirconium dichloride,

(3) (tetrahydroindenyl)1,3-dimethylcyclopentadienylzirconium dichloride,

(4) (tetrahydroindenyl)pentamethylcyclopentadienylzirconium dichloride,

(5) (tetrahydroindenyl)indenylzirconium dichloride,

(6) (tetrahydroindenyl)2-methylindenylzirconium dichloride,

(7) (tetrahydroindenyl)fluorenylzirconium dichloride,

(8) (tetrahydroindenyl)1-methylfluorenylzirconium dichloride,

(9) (tetrahydroindenyl)4H-azulenylzirconium dichloride,

(10) (tetrahydroindenyl)2-methyl-4H-azulenylzirconium dichloride,

(11) (2-methyltetrahydroindenyl)cyclopentadienylzirconium dichloride,

(12) (2-methyltetrahydroindenyl)indenylzirconium dichloride,

(13) (2-ethyltetrahydroindenyl)cyclopentadienylzirconium dichloride,

(14) (4-methyltetrahydroindenyl)cyclopentadienylzirconium dichloride,

(15) (2,4-dimethyltetrahydroindenyl)cyclopentadienylzirconium dichloride,

(16) (2-methyl-4-phenyltetrahydroindenyl)cyclopentadienylzirconium dichloride,

(17) (hexahydroazulenyl)cyclopentadienylzirconium dichloride,

(18) (2-methylhexayhydroazulenyl)cyclopentadienylzirconium dichloride,

(19) (2,4-dimethylhexahydroazulenyl)cyclopentadienylzirconium dichloride,

(20) (hexahydrocyclopentacyclooctenyl)cyclopentadienylzirconium dichloride,

(21) (octahydrocyclopentacyclodeccnyl)cyclopentadienylzirconium dichloride,

(22) (decahydrocyclopentacyclododecenyl)cyclopentadienylzirconium dichloride,

(23) (octahydrofluorenyl)cyclopentadienyizirconium dichloride,

(24) (¹-methyloctahydrofluorenyl)cyclopentadienylzirconium dichloride,

(25) (tetrahydroindenyl)cyclopentadienylzirconium monochloride monohydride,

(26) (tetrahydroindenyl)cyclopentadienylmethyizirconium monochloride,

(27) (tetrahydroindenyl)cyclopentadienylethylzirconium inonochloride,

(28) (tetrahydroindenyl)cyclopentadienylphenylzirconium monochloride,

(29) (tetrahydroindenyl)cyclopentadienylzirconium dimethyl,

(30) (tetrahydroindenyl)cyclopentadienylzirconium diphenyl,

(31) (tetrahydroindenyl)cyclopentadienyirconium dineopentyl, and

(32) (tetrahydroindenyl)cyclopentadienylzirconium dihydride.

Compounds obtained by replacing chlorine, in the exemplified transition metal compounds of the general formulae 1] and [2], with bromine, iodine, hydride, methyl, phenyl and the like may also be used. Further, according to the present invention, compounds obtained by replacing zirconium as the central metal, in the exemplified zirconium compounds, with titanium, hafnium, niobium, molybdenum, tungsten and the like may also used as the component [A].

Among them, zirconium compounds, hafnium compounds, and titanium compounds are preferred with zirconium compounds and hafnium compounds being more preferred.

The compound to be used as the component [B] of the catalyst according to the present invention is (a) an aluminumoxy compound, (b) a Lewis acid, (c) an ionic compound which can be reacted with the component [A] to convert the component [A] to a cation, or (d) an ion-exchangeable layered inorganic compound.

Some Lewis acids may be regarded also as the “ionic compound which can be reacted with the component [A] to convert the component [A] to a cation.” Therefore, compounds belonging to both the “Lewis acid” and the “compound which can be reacted with the component [A] to convert the component [A] to a cation” can be regarded as compounds belonging to any one of these categories.

Specific examples of preferred aluminumoxy compounds (a) include compounds represented by the following general formulae [3], 4], and [5]:

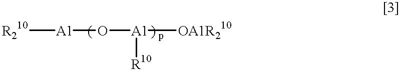

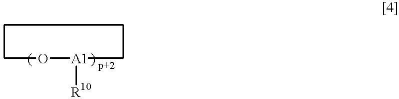

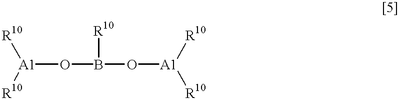

wherein p is a number of 0 to 40, preferably 2 to 30; and R¹⁰ represents a hydrogen atom or a hydrocarbon residue preferably having 1 to 10 carbon atoms, particularly preferably having 1 to 6 carbon atoms.

Compounds represented by the general formulae [3] and 4] ate compounds known also as alumoxanes and obtained by reacting one trialkylaluminum or two or more trialkylaluminums with water. Specific examples thereof include: (i) alumoxanes obtained from one trialkylaluminum and water, such as methylalumoxane, ethylalumoxane, propylalumoxane, butylalumoxane, and isobutylwumoxane; and (ii) alumoxanes obtained from two trialkylaluminums and water, such as methylethylalumoxane, methylbutylalumoxane, and methylisobutylalumoxane. Among them, methylalumoxane and methylisobutylalumoxane are particularly preferred.

A plurality of alumoxanes selected from the same category or different categories may be used in combination. Further, these alumoxanes may be used in combination with other alkyluium compounds, such as trimethylaluminum, triethylaluminum, triisobutylaluminum, and dimethylaluminum chloride.

They may be prepared by various conventional methods. Specific examples thereof include:

(a) a method wherein a trialkylaluminum is directly reacted with water in a suitable organic solvent, such as toluene, benzene, or ether;

(b) a method wherein a trialkylaluminium is reacted with a salt hydrate having water of crystallization, for example, a hydrate of copper sulfate or a hydrate of aluminum sulfate;

(c) a method wherein a trialkylaluminum is reacted with water impregnated into a compound usable as the component [C] (described in detail below), for example, silica gel;

(d) a method wherein tiaiethylaluminum is mixed with triisobutylaliumu to prepare a mixture which is directly reacted with water in a suitable solvent, such as toluene, benzene, or ether;

(e) a method wherein trimethylaluminum is mixed with triisobutylaluminum to prepare a mixture which is reacted with a salt hydrate having water of crystallization, for example, a hydrate of copper sulfate or a hydrate of aluminum sulfate;

(f) a method wherein impregnated silica gel or the like (usable as the component [C]) is treated with triisobutylaluminum and additionally treated with trimethylaluminum;

(g) a method wherein methylalumoxane and isobutylalumoxane are synthesized by conventional methods and mixed together in respective predetermined amounts, followed by a thermal reaction; and

(h) a method wherein a salt having water of crystallization such as copper sulfate pentahydrate, is placed in an aromatic hydrocarbon solvent, such as benzene or toluene, and reacted with trimethylaluminum at a temperature of −40° C. to +40C. In this case, the amount of water used is generally 0.5 to 1.5 in terms of molar ratio to trimethylaluminum. The methylalumoxane thus obtained is a linear or cyclic organoaluminium polymer.

Compounds represented by the general formula [5] may be obtained by reacting one trialkylaluminum or two or more trialkylaluminums and an (alkyl)boronic acid represented by the formula

R¹² B(OH)₂

wherein R¹² represents hydrogen or a hydrocarbon residue preferably having 1 to 10 carbon atoms, particularly preferably having 1 to 6 carbon atoms, in a ratio of 10:1 to 1:1 (molar ratio). Specific examples thereof include: (a) a reaction product of trimethylaluminum and methylboronic acid in a ratio of 2:1; (b) a reaction product of triisobutyluminum and methylboronic acid in a ratio of 2:1; (c) a reaction product of trimethylaluminum, triisobutylaluminum, and methylboronic acid in a ratio of 1:1:1; (d) a reaction product of trimethylaluminum and ethylboronic acid in a ratio of 2:1; and (e) a reaction product of triethylaluminum and butylboronic acid in a ratio of 2:1. These compounds represented by the general formula [5] may be used in combination of two or more. Further, they may be used in combination with other allcylaluminum compounds, such as trimethylaluminum, triethylaluminum, triisobutylaluminum, and dimethylaluminum chloride.

Examples of ionic compounds (c), which can be reacted with the component [A] to convert the component [A] to a cation, include those represented by the general formula [6]:

[K]^{e+}[Z]^{e-} (6)

wherein K represents an ionic cation component, and preferred cation components include, for example, carbonium, tropylium, ammonium, oxonium, sulfonium, and phosphorium cations, cations of metals which as such are likely to be reduced, and cations of organometals. Specific examples of these cations include triphenylcarbonium, diphenylcarbonium, cycloheptatrienium, indenium, triethylam onium, tripropylammonium, tibutylammonium, N,N-dimethylanilinium, dipropylammonium, dicyclohexylammoniuxa, triphenylphosphonium, trimethylphosphonium, tri(methylphenyl)phosphonium, triphenylsulfonium, triphenyloxonium, triethyloxonium, pyrinium, and silver, gold, platinum, copper, palladium, mercury, and ferrocenium ions.

In the general formula [6], Z represents an ionic anion component which serves as a counter anion (generally not coordinated) against a cation species converted from the component [A], and examples of anions usable herein include organoboron compound anions, organoaluminium compound anions, organogallium compound anions, organophosphorus compound anions, organoarsic compound anions, and organoantiony compound anions. Specific examples thereof include: (a) tetraphenylboron, tetraks(3,4,5-trifluorophenyl)boron, tetrakis(3,5-di(trifluoromethyl)phenyl)boron, tetrakis(3,5-di(t-butyl)phenyl)boron, and tetrakis(pentafluorophenyl)boron; (b) tetraphenylaluminuum, tetrakis(3,4,5-trifluorophenyl)aluuminum, tctakis(3,5-di(trifluoromethyl)phenyl)aluminum, tetrakis(3,5-di(t-butyl)phenyl)aluminum, and tetrakis(pentafiluorophenyl)aluminum; (c) tetraphenylgallium, tetakis(3,4,5-trifluorophenyl)galium, tetrakis(3,5-di(trifluoromethyl)phenyl)gallium, tetrakis(3,5-di(t-butyl)phenyl)gallium, and tetrakis(pentafluorophenyl)gallium; (d) tetraphenyl phosphorus and tetrakis(pentafluorophenyl phosphorus; (e) tetraphenylascnic and tetrakis(pentalluorophenyl)arsenic; (f) tetraphenyl antimony and tetrakis(pentafluorophenyl)antimony; and (g) decaborate, undecaborate, carbadecaborate, and decachlorodecaborate.

Various organoboron compounds may be exemplified as Lewis acids (b), particularly Lewis acids which can convert the component [A] to a cation. Specific examples thereof include triphenylboron, tris(3,5-difluorophenyl boron, tris(3,5-di(trimethylsilyl)phenyl)boron, and tris (pentafluorophenyl)boron.

These ionic compounds and Lewis acids may be used alone as the component [B], or alternatively may be used in combination with aluminumoxy compounds represented by the general formula [3], [4], or 15]. Further, they may be used in combination with other alkylaluminum compounds, such as trimethylaluminum, triethylaluminum, triisobutylaluminum, and diimethylaluminum chloride.

Ion-exchangeable phyllosilicates may be used as the ion-exchangeable layered inorganic compound (d). Ion-exchangeable phyllosilicates refer to silicate compounds having such a crystal structure wherein planes constituted by ion bonds or the like are parallelly stacked on top of one another by weak bonding force and ions contained therein are exchangeable, Most of the ion-exchangeable phyllosilicates are produced in natural form as a main component of clay minerals. The ion-exchangeable phyllosilicates, however, are not particularly limited to naturally occurring ones, and may be artificially synthesized ones.

Specific examples of ion-exchangeable phyllosilicates usable herein include conventional phyllosilicates described, for example, in Haruo Shirouza, “Nendokobutsugaku (Clay Minaeralogy” published by Asakura Shoten (1995), for example, the family of kaolins, such as dickite, nacrite, kaolinite, anauxite, metahalloysite, and haloysite; the family of serpentiites, such as chrysotile, rizaldite, and antigorite; the family of smectites, such as montmorillonite, saucornite, beidellite, nontronite, saponite, hecorite, and stevensite; the family of vermiculites, such as vermiculite; the family of micas, such as mica, illite, sericite, and glauconite; attapulgite; sepiolite; palygoraskite; bentonite; pyrophyllite; talc; and a group of chlorites. They may form a mixed layer.

Among them, the family of smectites, such as montmorillonite, sauconite, beidellite, nontronite, saponite, hectorite, stevensite, bentonite, and taeniolite, the family of vermiculites, and the family of micas are preferred.

Ion-exchangeable layered inorganic compounds other than phyllosilicates usable herein include ionic crystalline inorganic compounds having hexagonal closed packing type, antimony type, CdCl₂ type, Cdl₂ type and other layered crystal structures. Specific examples of ion-exchangeable layered inorganic compounds having such crystal structures include crystalline acid salts of polyvalent metals, such as α—Zr(HAsO₄)₂·H₂O, α—Zr(HPO₄)₂, α—Zr(KPO₄)₂·3H₂O, α—Ti(HPO₄)₂, α—Ti(HAsO₄)₂·H₂O, α—Sn(HPO₄)₂·H₂O, γ—Zr(HPO₄)₂γ—Ti(HPO₄)₂, and γ—Ti(NH₄PO₄)₂·H₂O.

When a compound with the volume of pores having a radius of not less than 20 Å as measured by mercury porosimetry being less than 0.1 cc/g is used as the ion-exchangeable layered inorganic compound (d), it is difficult to provide high polymerization activity. Therefore, use of a compound having a pore volume of not less than 0.1 cc/g, particularly 0.3 to 5 cc/g, is preferred. Although the ion-exchangeable layered inorganic compound (d) as such may be used without any treatment, the compound (d) is preferably chemically treated prior to use. In this case, the chemical treatment may be any of surface treatment for removing impurities deposited on the surface and treatment which influences the structure of the clay.

Specific examples of treatments usable herein include acid treatment, alkali treatment, salt treatment, and organic material treatnent. The acid treatment removes impurities present on the surface and, in addition, elutes cations of aluminum, iron, magnesium and the like in the crystal structure to increase the surface area. The alkali treatment breaks the crystal structure of th layered inorganic compound and hence creates a change in the structure of the layered inorganic compound. In the case of the salt treatment and the organic material treatment, ion composites, molecutar composites, organic derivatives and the like can be formed to vs the surface area and the layer-to-layer spacing. Replacement of exchangeable ions between layers with different large bulky ions through the utilization of the ion exchangeability can provide a layered material with increased layer-to-layer spacing. Specifically, the bulky ions function as a pillar for supporting a bulky ion layer structure and hence are called “pillars.” Insertion of a different material into between layers of the layered material is called “intercalation.”

Guest compounds for intercalation usable herein include: cationic inorganic compounds, such as TiCl₄ and ZrCl₄; metal alcoholates, such as Ti(OR)₄, Zr(OR)₄, PO(OR)₃, and B(OR)₃ wherein R represents allcy, aryl or the like; and metal hydroxde ions, such as [Al₃O₄(OH)₂₄]⁷⁺, [Zr₄(OH),_{14]}²+, and [Fe₃O(OCOCH₃)₆]⁺. These compounds may be used alone or as a mixture of two or more. In the intercalation of these compounds, polymers, obtained by hydrolyzing metal alcoholates, such as Si(OR)₄, Al(OR)₃, and GC(OR)₄, or alteatively colloidal inorganic compounds, such as SiO₂, or the like may also be allowed to coexist. Examples of pillars usable herein include oxides produced by heat dehydration after intercalation of the hydroxide ions between layers. The component [8] may be used either as such or after heat dehydration. Puther, solids described above may be used alone or as a mixture of two or more.

According to the present invention, not less than 40%, preferably not less tan 60%, of the exchangeable group 1 metal cation contained in the ion-exchangeable layered inorganic compound (d) before the lt treatment is preferably subjected to ion exchange with cations dissociated from the following salts Salts usable in the salt treatment for ion exchange purposes are compounds containing cations containIng at least one atom selected from ae group consisting of group 2 to 14 atoms, preferably compounds comprising cations containing at least one atom selected from the group consisting of group 2 to 14 atoms and anions of at least one member selected from the group consisting of halogen atoms, inorganic acids, and organic acids, more preferably compounds comprising cations containing at least one atom selected from the group consisting of group 2 to 14 atoms and anions of at least one member selected from the group consisting of Cl, Br, I, F, PO₄, SO₄, NO₃, CO₃, C₂O₄, ClCO₄, OCOCH₃, CH₃COCHCOCH₃, OCl₂, O(NO₃)₂, O(ClO₄)₂, O(SO₄), OH, O₂Cl₂, OCl, OCOH, OCOCH₂CH_{3,} C₂H₄O₄, and C₆H₅O₇. Specific examples thereof include CaCl₂, CaSO₄, CaC₂O₄, Ca(NO₃)₂, Ca₃(C₆H₅O₇)₂, MgCl₂, MgBr₂, MgSO₄, Mg(PO₄)₂, Mg(ClO₄)₂, MgC₂O₄, Mg(NO₃)₂, Mg(OCOCH₃)₂, MgC₄H₄O₄, Sc(OCOCH₃)₂, Sc₂(CO₃)₃, Sc₂(C₂O₄)₃, Sc(NO₃)₃, SC₂(SO₄)₃, SF₃, ScCl₃, ScBr₃, ScI₃, Y(OCOCH₃)₃, Y(CH₃COCHCOCH₃)₃, Y₂(CO₃)₃, Y₂(C₂O₄)₃, Y(NO₃)₃, Y(ClO₄)₃, YPO₄, Y₂(SO₄)₃, YF₃, YCl ₃, La(OOCH₃)₃, La(CH₃COCHCOCH₃)₃, La₂(CO₃)₃, La(NO₃)₃, La(ClO₄)₃, La₂(C₂O₄)₃, LaPO₄, La₂(SO₄)₃, LaF₃, LaCl₃, Lar₃, LaI₃, Sm(OCOCH₃)₃, Sm(CH₃COCHCOCH₃)₃, Sm₂(CO₃)₃, Sm(NO₃)₃, Sm(ClO₄)₃, Sm₂(C₂O₄)₃, SmO₄, Sm₂(SO₄)₃, SmF₃, SmCl₃, SmBr₃, SMI₃, Yb(OCOCH₃)₃, Yb(NO₃)₃, Yb(ClO₄)₃, Yb(C₂O₄)₃, Yb₂(SO₄)₃, YbF₃, YbCl₃, Ri(OCOCH₃)₄, Ti(CO₃)₂, Ti(NO₃)₄, Ti(SO₄)₂, TiF₄, TiCl₄, TiBr₄, TiI₄, Zr(OCOCH₃)₄, Zr(CO₃)₂, Zr(NO₃)₄, Zr(SO₄)₂, ZrF₄, ZrCl₄, ZrBr₄, Zrl₄, ZrOCl₂, ZrO(NO₃)₂, ZrO(ClO₄)₂, Zr(SO₄), Hf(OCOCH₃)₄, H(CO₃)₂, Hf(NO₃)₄, Hf(SO₄)₂, HfOCl₂, HfF₄, HfCl₄, HfBr₄, HfI₄, V(CH₃COCHCOCH₃)₃, VOSO₄, VOCl₃, VCl₃, VCl₄, VBr₃, Nb(CH₃COCHCOCH₃)₅, Nb₂(CO₃)₅, Nb(NO₃)₅, Nb₂(SO₄)₅, ZrF₅, ZrCl₅, NbBr₅, Nbl₅, Ta(OCOCH₃)₅, Ta(CO₃)₅, Ta(NO₃)₅, Ta₂(SO₄)₅, TaF₅, TaCl₅, TaBr₅, TaI₅, Cr(OOCH₃)₂OH, Cr(CH₃COCHCOCH₃)₃, Cr(NO₃)₃, CT(ClO₄)₃, CrPO₄, Cr₂(SO₄)₃, CrO₂Cl₂, CrF₃, CrCl₃, CrBr₃, CrI₃, MoOCl₃, MoCl₃, MoC₄, MoCl₅, MoF₆, Mol₂, WCl₄, WCl₆, WF₆, WBr₅, Mn(OOCH₃)₂, Mn(CH₃COCHCOCH₃)₂, MnCO₃, Mn(NO₃)₂, MnO, Mn(ClO₄)₂, MnF₂, MnCl, MnBr₂, MnI₂, Fe(OCOCH₃)₂, Fe(CH₃COCHCOCH₃)₃, FeCO₃, Fe(NO₃)₃, Fe(ClCO₄)₃, FePO₄, FeSO₄, FeC₂(SO₄)₃, FeF₃, FeCl₃, FeBr₃, FeI₂, FeC₆H₅O₇, Co(OCOCH₃)₂, Co(CH₃COCHCOCH₃)₃, CoCO₃, Co(No₃)₂, CoC₂O₄, Co(ClO₄)₂, Co₃(PO₄)₂, CoSO₄, CoF₂, CoCl, CoBr₂, COI₂, NiCO₃, Ni(NO₃)₂, Ni(ClO₄)₂, NiSO₄, NiCl₂, NiBr₂, Pb(OCOCH₃)₄, Pb(OOCH₃)₂, PbCO₃, Pb(NO₃)₂, PbSO₄, PbHPO₄, Pb(ClO₄)₂, PbF₂, PbCl₂, PbBr₂, PbI₂, CuBr₂, CuBr₂, Cu(NO₃)₂, CuC₂O₄, Cu(ClO₄)₂, CuSO₄, Cu(OCOCH₃)₂, Zn(OOCH₃)₂, Zn(CH₃COCHCOCH₃)₂, ZnCO₃, Zn(NO₃)₂, Zn(ClO₄)₂, Zn₃(PO₄)₂, ZnSO₄, ZnF₂, ZnCl₂, ZnBr₂, ZnI₂, Cd(OCOCH₃)₂, Cd(CH₃COCHCOCH₃)₂, Cd(OCOCH₂CH₃)₂, Cd(NO₃)₂, Cd(ClO₄)₂, CdSO₄, CdF₂, CdCI₂, CdBr₂, Cdl₂, AlF₃, AlCl₃, AlBr₃, AlI₃Al₂(SO₄)₃, Al₂(C₂O₄)₃, Al(CH₃COCHCOCH₃)₃, Al(NO₃)₃, AlPO₄, GeCl₄, GeBr₄, Gel₄, Sn(OCOCH₃)₄, Sn(SO₄)₂, SnF₄, SnCl₄, SnBr₄, and SnI₄. The add treatment can remove impurities present on the surface and, in addition, can paitly or entirely elute cations of aluminum, iron, magnesium and the like in the crystal structure.

The acid used in the acid treatment is preferably selected from hydrochloric acid, sulfuric acid, nitric acid, oxalic acid, phosphoric acid, and acetic acid. Two or more salts and acids may be used in the treatment. Methods usable in the practice of the salt treatment in combination with the acid treatment include: one wherein the acid treatment is carried out after the salt treatment; oine wherein the salt treatment is carried out after the acid treatment; and one wherein the salt treatment and the acid treabnent are simultaneously carried out.

Conditions for the treatment with the salt and the treatment with the acid are not pacularly limited. In general, however, preferably, treatment conditions are selected so that the salt and acid concentrations are 0.1 to 30% by weight, the treatment temperature is room temperature to the boiling point, and the treatment time is 5 min to 24 hr, and the treatment is carried out so that at least a part of at least one compound contained in the ion-exchangeable layered inaorganic compounds is cluted. The salt and the acid each are generally used in the form of an aqueous solution.

According to the present invention, preferably, the salt treatment and/or the acid treatment are cned out. In this case, the control of the shape may be carried out by grinding, granulation or the like before, during, or after the treatment. Further, the shape control may be carried out in combination with chemical treatment, such as lkslai treatment or organic material treatment,

These ion-exchangeable layered inorganic material generally contains adsorbed water and water contained between layers. According to the present invention, preferably, the adsorbed water and the water contained between layers are removed before use of the ion-exchangeable layered inorganic compound particles as the component [B].

The term “adsorbed water” used herein refers to water adsorbed on the surface of ion-exchangeable layered inorganic compound particles or the fractured surface of the crystal, and the term “water between layers” refers to water which is present between layers of the crystal. According to the present invention, the adsorbed water and/or the water between layers may be removed by heating before use of the ion-exchangeable layered inorganic compound particles.

The adsorbed water and the water between layers may be removed by any heat treatment method without particular liitation, and examples of heat treatment methods usable herein include heat dehydration, heat dehydration while passage of a gas, beat dehydration under reduced pressure, and azeotropic dehydration with an organic solvent. The temperature in the heating cannot be unconditionally specified because it depends upon the ion-exchangeable layered inorganic compound used and the ions between layers. in general, heating is carried out at 100° C. or above, preferably 150° C. or above, so that the presence of water between layers can be avoided. In this case, however, heating at such a high temperature as wil cause brealing of the structure (for example, at 800° C. or above although the temperature depends upon the heating time) is unfavorable. Beat dehydration by heating while passage of air is unfavorable because this results in the formation of a crossbnked structure which disadvantageously lowers the polymerization activity of the catalyst. The heating time is not less than 0.5 hr, preferably not less than one hr. In this case, the water content of the component [B] after the removal of water is generally not more than 3% by weight, preferably not more than 1% by weight, assuming that the content of water after dehydration under conditions of temperature 200° C. and pressure 1 mamHg for 2 hr is 0% by weight.

As described above, according to the present invention, the component [B] is particularly preferably an ion-exchangeable layered inorganic compound, having a water content of not more than 1% by weight, obtained by the salt treatment and/or the acid treatment.

The component [B] is preferably in the form of granular particles having an average particle diameter of not less than 5 μm, more preferably in the form of spherical particles having an average particle diameter of not less than 10 μm, still more preferably in the form of spherical particles having an average particle diameter of 10 to 100 μm. The average particle diameter referred to herein is expressed in terms of number average particle diaimeter determined by image processing of an optical microphotograph (at a magnification of 100 tinmes) of particles. When the component [B] is in the form of spherical particles, a naturally occuning product or a commercially available product as such may be used. Alternatively, prior to use, the shape and the particle diameter of the particles may be regulated by granulation, sizing, fractionation or the like.

Granulation methods usable herein include agitation granulation, spray granulation, tumbling granulation, briquetting, compacting, extrusion granulation, fluidized bed granulation, emulsion granulation, submerged granulation, and compression granulation. The granulation method, however, is not particularly limited so far as the component [B] can be granulated. Preferred granulation methods include agitationa granulation, spray granulation, tumbling granulation, and fluidized bed granulation. Particularly preferred are agitation granulation and spray granulation. In the case of spray granulation, water or an organic solvent, such as methanol, ethanol, chloroform, meithylene chloride, pentane, hexane, heptane, toluene, or xylene, is used as a dispersion medium for a starting slurry. Preferably, water is used as the dispersion medium. The concentration of the component [B] in the starig sluay used in the spray granulation for the production of spherical paricles is 0.1 to 70%, preferably 1 to 50%, particularly preferably 5 to 30%. The temperature of the hot air at the inlet in the spray granulation for the production of spherical particles varies depending upon the dispersion medium. For example, when the dispersion medium is water, the inlet temperature is 80 to 260° C., preferably 100 to 220°.

Further, in the granulation, organic materials, inorganic solvents, inorganic salts, and various binders may be used. Binders usable herein include, for example, sugar, dextrose, corn syrup, gelatin, glue, carboxymethylcelluloacs, polyvinyl alcohol, water glass, magnesium chloride, aluminum sulfate, aluminum chloride, magnesium sulfate, alcohols, glycols, starch, casein, latex, polyethylene glycol, polyethylene oxide, tar, pitch, alumina sol, siica gel, gum arabic, and sodium alginate.

Preferably, sphencal particles thus obtained have a crushing strength of not less than 0.2 MPa from the viewpoint of inhibiting cum g or powdering of the particles in the step of polymerization. When the spherical particles have the above strength, the effect of improving the properties of the paicles can be effectively attined particularly in prepolymerization. According to the present invention, the component [3] is preferably an ion-exchangeable layered inorganic compound (d) when the granulation and the cost of the catalyst and the molecular weight of the ethylene polymer are taken into consideration.

The organoaluminurm compound optionally used as the component [C] in the present invention is represented by the gcneral formula

wherein R¹¹ represents a hydrocarbon group having 1 to 20 carbon atoms; X, represents hydrogen, a halogen, or an alkoxy or sloxy group; and m is an integer of 0<m<3.

Specific examples of organoaluminum compounds usable herein include: trialkylaluminums, such as trimethylaluminum, triethylaluminum, tripropylumum, and triisobutylaluminum; and halogen- or alkoxy-containing alliyaluminums, such as diethylaluminum monochloride and diethylaluminum monomethoxide. Among them, trialuylaluminums are particularly preferred.

The component [A], the component [B], and the optional component [C] may be contacted with one another by any method without particular limitation. For example, they may be contacted in the following order.

a. The component [A]is contacted with the component [B].

b. The component [A] is contacted with the component [B]. followed by addition of the component [C].

c. The component [A] is contacted with the component [C], followed by addition of the component [B].

d. The component [B] is contacted with the component [C], followed by addition of the component [A].

This contact may be carried out at the time of the preparation of the catalyst, as well as at the time of prepolymerization or polymerization of an olefin.

Further, the three components may be simultaneously contacted with one another.

At the time or after the contact of the catalyst components, an olefin polymer, a styrene polymer, an acrylic polymer or other homopolymer, an olefin, styrene, acrylic or other copolymer, or a solid of an inorganic oxide, such as silica or alumina, may be allowed to coexist or may be contacted. The contact may be carried out in an inert gas, such as irogen, or an inert hydrocarbon solvent, such as pentane, hexane, heptane, toluene, or xylene. The contact temperature preferably ranges from −20° C. to the boiling point of the solvent, particularly preferably from room temperature to the boiling point of the solvent.

The amount of each catalyst component is such that the amount of the component [A] is generally 0.0001 to 10 mmol, preferably 0.001 to 5 mmol, per g of the component [B] and the amount of the optional component [C] is 0.01 to 10000 mmol, preferably 0.1 to 100 mmol, per g of the component [B]. The molar ratio of the transition metal in the component [A] to the aluminum atom in the component [C] is 1:0.01 to 1000000, preferably 1:0.1 to 100000.

The catalyst thus obtained may be used as an olefin polymerization catalyst after washing, or alternatively may be used as such for the polymztion without washing.

According to the present invention, when the compounds (a) to (c) are used as the component [B], the component [B] may be used in combination with an organic or inorganic particulate porous carrier as component [D].

Examples of organic caniers usable herein include (a) α-olefin polymers preferably having 2 to 10 carbon atoms, for example, polyethylene, polypropylene, polybutene- 1, ethylene-propylene copolymer, ethylene-butene-1 copolymer, ethylene-hexane-1-copolymer, propylene-butene-1 copolymer, propylene-hexene-1 copolymer, and propylene-divinylbenzene copolymer, (b) aromatic unsaturated hydrocarbon polymers, for example, polystyrene and styrene-divinylbenzene copolymer, and (c) polar group-containing polymers, for example, polyacrylic esters, polymethacrylic esters, polyacrylonitrile, polyvinyl chloride, polyamide, polyphenylene ether, polyethylene terephthalate, and polycbonate.

Inorganic carriers usable herein include (a) inorganic oxides, for example, SiO₂, Al₂O₃, MgO, ZrO₂, TiO₂, B₂O₃, CaO, ZnO, BaO, ThO₂, SiO₂—Mg(O, SiO₂—Al₂O₃, SiO₂—TiO₂, SiO₂—V₂O₅, SiO₂—Cr₂O₃, and SiO₂—TiO₂—MgO, (b) inorganic halides, for example, MgCl₂, AlCl₃, and MnCl₂, (c) inorganic carbonates, sulfates, and nitrates, for example, Na₂CO₃, K₂CO₃, CaCO₃, MgCO₃, Al₂(SO₄)₃, BaSO₄, KNO₃, and Mg(NO₃)₂, and (d) oxides, for example, Mg(OH)₂, Al(OH)₃, and Ca(OH)₂. Clay minerals, clay, and ion-exchangeable layered compounds are excluded from the inorganic carriers usable in the present invention.

For these carriers, the volume of pores having a size of 0.006 to 10 μm is generally not less than 0.1 cc/g, preferably not less than 0.3 cc/g, more preferably not less 0.8 cc/g. The carriers are particularly preferably such that the total volume of pores having a size in the range of 0.05 to 2 μm is not less than 50% of the total volume of all pores having a s in the rangeof 0.006 to 10 μm.

The carrier particles may have any diameter. The particle diameter, however, is generally 1 to 3000 μm, preferably 5 to 2000 μm, more preferably 10 to 1000 μm.

Preferred are cariers of organic compounds, preferably α-olefin polymers having 2 to 10 carbon atoms, wherein the total volume of pores having a size of 0.006 to 10 μm is not less than 1.0 cc/g with the total volume of pores having a se of 0.05 to 2 a iA being not less than 50% of the total volume of all pores lhaving a size of 0.006 to 10 μm.

Regarding the combination of catalyst components of the catalyst according to the present invention, paicularly preferably, when the catalyst comprises [A]+[B], the components [A] and [B] may be contacted with each other outside or within a polymerization tank to prepare a catalyst. In this case, the contact may be carried out in any sequence. when the catalyst comprises [A]+[B]+[D], the components [A], [B], and [D] may be contacted with one another outside or within the polymerization tank to prepare a catalyst. In this case, the contact may be carried out in any sequence. A preferred contact method is such that, after the component [D] is previously contacted with the component [B] or after the component [B] is synthesized in the presence of the component [D], the remaining component is contacted. When the catalyst comprises [A]+[B]+[C]+[D], the components [A], [B], [C], and [D] may be contacted with one another outside or within the polymerization tank to prepare a catalyst. In this case, the contact may be carried out in any sequence. A preferred contact method is such that after the component [B] is previously contacted with the component [D] outside the polymerization tank, the component [A] is then contacted. A more preferred method is to add the component [C] to a mixture of the components [B] and [D] simultaneously with or immediately after the addition of the component [A].

After the contact (addition/reaction) of the components, washing with an aliphatic hydrocarbon or aromatic hydrocarbon solvent is possible and preferred.

According to the present invention, the components [A], [P], [C] and/or [D] may be used in any amount. For example, the amount of the component [A] used per g of the component [D] is preferably 10⁻¹⁰ to 10⁻³ moles, more preferably 10⁻⁸ to 10⁻⁴ moles, in terms of transition metal atom. For the amount of the component [B] used, when the aluminum oade compound is used as the component [B], the Al/component [A] molar ratio is generally 1 to 50,000, preferably 10 to 10,000, particularly preferably 50 to 5,000. On the other hand, when the ionic compound or the Lewis acid is used as the component [B], the component [B]/component [A] molar ratio is 0.1 to 1,000, preferably 0.5 to 100, more preferably 1 to 50.

If the component [C] is used, the amount thereof is preferably not more than 10⁵, more preferably not more than 10⁴, partcularly preferably not more than 10³.

The catalyst of the present invention may be and is preferably subjected to prepolymeuzation treatment wherein the catalyst is contacted with a polymerizable monomer to polymerize a minor amount of the monomer, The monomer used in the prepolymerization may be an α-olefin, preferably ethylene. The amount of the prepolymerization is generally 0.01 to 1000 g, preferably 0.1 to 50 g, per g of the component [D].

Olefins usable in the polym tion include ethylene, propylene, 1-butene, 1-hexene, 1-octene, 4-methyl- 1-pentene, 3-methyl- 1-butene, vinylcycloalkane, stene, or derivatives of the above olefins. The catalyst of the present invention may be sutably used in homopolymerization, as well as in conventional random copolymerization and block copolymerization. Further, the catalyst may also be used in copolymaization of diene compounds, such as butadiene, 1,5-hexadiene, 1,7-octadienc, methyl- 1,4hexadiene, and methyl-1,7-octadiene, with the olefin.

Before the polymerization, an olefln, such as ethylene, propylcnc, 1-butene, 1-hexene, 1-octene, 4-methyl-1-pentene, 3-methyl-1-butene, vinylcycloalkane, or styrene, may be preliminiarily polymerized in the presence of the catalyst of the present invention. Preferably, this prepolymerization is carred iout in an inert solvent under mild conditions. Further, preferably, the prepolymerization is carried out so that a polymer in an amount of 0.01 to 1000 g, preferably 0.1 to 100 g, per g of the solid catalyst is produced.

Polymerization may be carried out in the presence or absence of a solvent, for example, an inert hydrocarbon, such as butane, pentane, hexane, heptane, toluene, or cyclohexne, or a liquefied α-olefin. The temperature is −50° C. to 250° C. Although the pressure is not paricularly limited, it is preferably normal pressure to 2000 kgf/cm².

Hydrogen may be allowed to exist as a molecular weight modifier in the polymerization system. Futer, the polymerization temperature, the concentration of the molecular weight modifier and the like may be varied to conduct multi-stage polymerization.

The following examples farther illustrate the present invention but are not intended to limit it so far as they do not depart from the subject matter of the invention.

The synthesis of catalysts and the polymerization in the following examples were carried out in an atmosphere of purified nitrogen. Solvents, prior to use, were dehydrated by Molecular Sieves 4A and then bubbled by purified nitrogen for deaeration.

In the following examples, copolymerization of ethylene and 1-butene is described. In this case, the composition ratio of ethylene and 1-butene introduced into the polyme tion tank was properly varied according to the catalyst used so that copolymers having substantially the same density can be produced.

In the examples, MFR (melt flow rate) was measured under conditions of 190° C. and load 2.16 kg according to ASTM D 1238. In the measurement of MAR, 0.1% by weight of 2,6-di-t-butyl-p-cresol was incorporated into the polymer.

### EXAMPLE 1

(1) Synthesis of bis(2-methyltetrahydroindenyl)zirconium dichloride

To a solution of 0.68 g (5.2 mmol) of 2-methylindene in n-hexane (10 ml) was dropwise added 3.6 ml of a solution (1.53 M) of n-butyl lithium (5.5 rnmol) in n-hexane at 0° C. After the completion of the addition, the reaction solution was stirred for 4 hr while gradually raising the temperature to room temperature. The solvent was removed by distillation under the reduced pressure. The residue was then cooled to −78° C. 20 ml of dichioromethane was added thereto. Further, a slurry of 0.58 g (2.5 mmol) of zirconium tetrachloride in 10 ml of dichloromethane was added thereto at that temperature. The temperature of the mixture was then gradually raised to room temperature, followed by a reaction while stirring at room temperature for 4 hr. The reaction solution was filtered through Celite. The filtrate was concentrated under the reduced pressure. 50 ml of n-hexane was added thereto to precipitate a solid. The solid was washed three times with 30 ml of n-hexane. The solvent was then removed by distillation under the reduced pressure to give 715 mg of bis(2-methylindenyl)zirconium dichloride.

0.52 g (1.2 mmnol) of bis(2-methyhindenyl)zirconmum dichloride was then dissolved in 50 ml of dichioromethane. The solution, together with 50 mg of platinum dioxide, was introduced into a 0.1 liter autoclave. Hydrogen was introduced into the autoclave until the internal pressure reached 10 kg.f/cm². The system was stirred at room temperature for one hr, thereby permitting a reaction to proceed. After purging with hydrogen, the reaction solution was filtered through Celite. The solvent was removed from the filtrate by distillation under the reduced pressure to give 429 mg of bis(2-methyltetrahydroindenyl)zirconium dichloride.

(2) Chemical treatment of clay mineral

30 g of commercially available synthetic mica was dispersed in a solution of 52.5 g of ZnSO₄·7H₂O in 600 ml of desalted water. The dispersion was sired at 90° C. for 3 hr. After the treatment, the solid component was washed with desalted water and dried to obtain Zn slt-treated synthetic mica.

(3) Heat dehydration of clay mineral

10.0 g of the Zn salt-treated synthetic mica prepared in the step (2) was placed in a 200 ml flask, and heat dehydrated at 200° C. for two hr under the reduced pressure. The heat dehydration caused a weight loss of 1.16 g.

(4) Synthesis of catalyst component

1.0 g of the Zn salt-treated synthetic mica obtained in the step (3) was placed in a 100 ml flask, and dispersed in 7 ml of toluene to prepare a slurry. 0.43 ml of tiethyl aluminum was added to the slurry with stirring at room temperature. The slurry was contacted with triethyl aluminum at room temperature for one hr. Thereafter, the supernatant was withdrawn, and the solid matter was washed with toluene. Toluene was added thereto to prepare a slurry. 20.0 ml of a toluene solution (10.0 μ mmol/ml) of bis(2-methyltetrahydroindenyl)zirconium dicioride synthesized in the step (1) was added to the slury. The mixture was stirred at room temperature for one hr to give a catalyst component.

(5) Copolymerization of ethylene and 1-butene

840 ml of n-hexane, 0.25 mmol of triethyl aluminum, and 160 ml of 1-butene were placed in a 2-liter induction siring type autoclave satisfactorily purged with purified nitrogen. The system was heated to 70° C., and 30.0 mg, on a solid catalyst basis, of the catalyst component prepared in the step (4), together with ethylene, was introduced into the system. Stirring was continued for one hr while maitining the total pressure at 25 kg.f/cm² to cary out polymerization. The polymerization was terminated by adding 10 ml of ethanol. The amount of the ethylene-1-butene copolymer thus obtained was 270 g. This copolymer had a very low MFR of 0.01 g/10 min and thus had high molecular weight. The amount of hydrogen evolved per g of the ethylene copolymer was as small as 0.006 mmol.

Comparatie Example 1

(1) Synthesis of catalyst component and copolymerization of ethylene with 1-butene

A catalyst component was synthesized in the same manner as in Example 1, except that bis(2-methylindenayl)zirconium dichloride was used instead of bis(2-methyltetrahydroindenyl)zirconium dichloride in the step (4) of Example 1. Ethylene was then copolymezd with 1-butene in the same manner as in the step (5) of Example 1, except that the amount of the catalyst comrponent used in the polymerization was changed to 20.0 mg on a sold catalyst basis. As a result, the amount of the ethylene-1-butene copolymer thus obtained was as small as 28 g, indicating that the catalyst had low activity. Further, for this copolymer, the MFR was 0.02 g/10 min, and the amount of hydrogen evolved per g of the ethylene copolymer was 0.008 mmol.

### COMPARATIVE EXAMPLE 2

(1) Synthesis of catalyst component and copolymerization of ethylene with 1-butene

A catalyst component was synthed in the same manner as in Example 1, except that diimethylsilylenebis(2-methyltetrahydroindenyl)zircoriium dichloride was used instead of bis(2-methyltetrahydroindenyl)zirconium dichloride in the step (4) of Example 1. 950 ml of n-hexane, 0.25 mmol of triethylaluminum, and 50 ml of 1-butene were placed in a 2-liter induction stirring type autoclave satisfactorily purged with purified nitrogen. The temperature of the system was raised to 70° C. Ethylene was then copolymeized with 1-buteuc in the same manner as in the step (5) of Example 1, except that the amount of the catalyst component used in the polymerization was changed to 10.0 mg on a solid catalyst basis. Thus, 156 g of an ethylene-1-butene copolymer was obtained. This copolymer had an MFR of 0.24 g/10 mnin and thus had unsatisfactory molecular weight. Fier, the amount of hydrogen evolved per g of the ethylene copolymer was 0.004 mmol.

### EXAMPLE 2

(1) Synthesis of bis(tetrahydroindenyl)zirconium dichloride

The procedure of Example 1 was repeated, except that 0.58 g of indene was used instead of 0.68 g of 2-methylindene in the step (1) of Example 1. Thus, 451 mg of bis(tetrahydroindenyl)zrconium dichloride was prepared.

(2) Synthesis of catalyst component and copolymeization of ethylene with 1-butene

A catalyst component was synthesized in the same manner as in Example 1, except that bis(tetrahydroindenyl)zirconium didhloride obtained in the step (1) just above was used instead of bis(2-methyltetrahydroindenyl)zirconium dichloride in the step (4) of Example 1. Ethylene was then copolymerized with 1-butene in the me manner as in the step (5) of Example 1, except that the amount of the catalyst component used in the polymerization was changed to 3.0 mg on a solid catalyst basis. As a result, 250 g of an ethylene-1-butene copolymer was obtained. For this copolymer, the MFR was 0.3 g/10 min, ad the amount of hydrogen evolved per g of the ethylene copolymer was 0.011 mmol.

### EXAMPLE 3

(1) Synthesis of catalyst component and copolymerization of ethylene with 1-butene

A catalyst component was synthesized in the same manner as in Example 2, except that a hafnium complex was used instead of the zirconium complex in Example 2 Ethylene was copolymeized with 1-butene in the same manner as in the step (5) of Example 1, except that the amount of the catalyst component used in the polymerization was changed to 30.0 mg on a solid catalyst basis, The amount of the ethylene-1-butene copolymer thus obtained was 250 g. This copolymer had an MFR of 0.03 g/10 min and thus had high molecular weight. The amount of hydrogen evolved per g of the ethylene copolymer was as small as 0.009 mmol.

### COMPARATIVE EXAMPLE 3

(1) Synthesis of catalyst component and copolymerization of ethylene with 1-butene

A catalyst component was synthesd in the same manner as in Example 1, except that bis(indenyl)zirconium dichloride was used instead of bis(2-methyltetrahydroindenyl)zirconium dichloride in the step (4) of Example 1. Ethylene was then copolymerizd with 1-butene in the same manner as in the step (5) of Example 1, except that the amount of the catalyst component used in the polymerization was changed to 15.0 mg on a solid catalyst basis. As a result, 130 g of an ethylene-l-butene copolymer was obtained. This polymer had an MFR of 0.65 g/ 10 min and thus had unsatisfactory molecular weight, and the amount of hydrogen evolved per g of the ethylene copolymer was 0.014 mmol.

### COMPARATIVE EXAMPLE

(1) Synthesis of catalyst component and copolymerization of ethylene with 1-butene

A catalyst component was syntheed in the same manner as in Example 1, except that dimethylslylenebis(tetrahydroidenyl)zirconium dichloride was used instead of bis(2-metnylttahydroindenyl)zirconium dichlotide in the step (4) of Example 1. 950 ml of n-hexane, 0.25 mmol of triethylalumraum, and 50 ml of 1-butene were placed in a 2-liter induction sting type autoclave satisfactorily purged with purified nitrogen. The temperature of the system was raised to 70° C. Ethylene was then copolymerized with 1-butene in the me manner as in the step (S) of Example 1, except that the amount of the catalyst component used in the polymeuzation was changed to 20.0 mg on a solid catalyst basis. Thus, 150 g of an ethylene-1-butene copolymer was obtained This copolymer had an MFR of 0.79 g/10 win and thus had unsatisfactory molecular weight. Further, the amount of hydrogen evolved per g of the ethylene copolymer was 0.002 mrmol.

### EXAMPLE 4

(1) Synthesis of (octahydrofluornyl)cyclopcnitadienylzirconium dichloride

To a solution of 1.08 g (6.5 mmol) of fluorene in n-hexane (20 ml) was dropwise added 4.6 ml (7.1 mmol) of a solution (1.53 M) of n-butyllthium in n-hexane at 0° C. After the completion of the addition, the reaction solution was stirred for 4 hr while gradually raising the temperature to room temperature. The solvent was removed by distillation under reduced pressure. The residue was then cooled to −78° C. 30 ml of dichloromethane was added thereto. Further, a slurry of 1.65 g (6.3 mmol) of monocyclopentadienylzirconium trichloride in 30 ml of dichloromethane was added thereto at that temperature. The temperature of the mixture was then gradually raised to room temperature, followed by a reaction while stifling at room temperature for 4 hr. The reaction solution was filtered through Celite. The filtrate was concentrated under the reduced pressure. 70 ml of n-hexane was added thereto to precipitate a solid. The solid was washed three times with 50 ml of n-hexanc,. The solvent was then removed by distillation under the reduced pressure to give 1.65 g of (fluorenyl)cyclopentadienylzirconium dichloride.

0.56 g (1.4 mmol) of (fluorenyl)cyclopentadienylzirconium dichloride was then dissolved in 50 ml of dichloromethane. The solution, together with 50 mg of platinum dioxde, was introduced into a 0.1 liter autoclave. Hydrogen was introduced into the autoclave until the internal pressure reached 10 kg·f/cm². The system was stirred at room temperature for one hr. thereby permitt a reaction to proceed. After purging with hydrogen, the reaction solution was fltered through Celite. The solvent was removed from the fitrate by distillation under the reduced pressure to give 168 mg of (octahydrofluorenyl)cyclopentadienylzirconium dichloride.

(2) Synthesis of catalyst component and copoymeization of ethylene with 1-butene

A catalyst component was synthesized in the same manner as in Example 1, except that (octahydrofluorenyl)cyclopentadienylzireonium dicloxide obtained in the step (1) just above was used instead of bis(2-methyltctrahydroindenyl)zirconium diciloride in the step (4) of Example 1. Ethylene was then copolymerized with 1-butene in the same manner as in the step (5) of Example 1. As a result, 250 g of an ethylene 1-butene copolymer was obtained. F er, for this copolymer, the MFR was 0.1 g/10 min, and the amount of hydrogen evolved per g of the ethylene copolymer was 0.008 mmol.

### COMPARATIVE EXAMPLE 5

(1) Synthesis of catalyst component and copolymerization of ethylene with 1-butene

A catalyst component was synthesized in the same manner as in Example 1, except that (fluorenyl)cyclopentadienylzirconium dichloride was used instead of bis(2-methyltetrabydroindenyl)zircoum dichloride in the step (4) of Example 1. Ethylene was then copolyered with 1-butene in the same manner as in the step (5) of Example 1, except that the amount of the catalyst component used in the polymerization was changed to 15.0 mg on a solid catalyst basis. As a result, the amount of the ethylene-1-butene copolyrer thus obtained was as small as 13 g, indicating that the catalyst had low activity. Further, for this copolymer, the MFR was 0.07 g/10 min, and the amount of hydrogen evolved per g of the ethylene copolymer was 0.014 mmol.

### COMPARATIVE EXAMPLE 6

(1) Synthesis of catalyst component and copolymerization of ethylene with 1-butene

A catalyst component was synthesized in the same manner as in Example 1, except that isopropylidene(fluorenyl)cyclopentadienyirconium dichloride was used instead of bis(2-methyltetrahydroindenyl)zirconium dichloride in the step (4) of Example 1.950 ml of n-hexane, 0.25 mmol of triethylaluminum, and 50 xal of 1-butene were placed in a 2-liter induction stiring type autoclave satisfactorijy purged with purified nitrogen. The temperature of the system was raised to 70° C. Ethylene was then copolymerized with 1-butene in the same manner as in the step (5) of Example 1, except that the amount of the catalyst component used in the polymerization was changed to 20.0 mg on a solid catalyst basis. Thus, 56 g of am ethylene-1-butene copolymer was obtained. This copolymer had an MFR of 1.76 g/10 mi and thus had unsatisfactory molecular weight. Further, the amount of hydrogen evolved per g of the ethylene copolymer was as large as 0.031 mmol.

### COMPARATIVE EXAMPLE 7

(1) Synthesis of catalyst component and copolymerization of ethylene with 1-butene

A catalyst component was synthesized in the same manner as in Example 1, except that bis(n-butylcyclopentadienyl)zirconium dichloride was used instead of bis(2-methyltctrahydroindenyl)zirconium dichloride in the step (4) of Example 1. Ethylene was then copolymerized with 1-butene in the same manner as in the step (5) of Example 1, except that the amount of the catalyst component used in the polymerization was changed to 15.0 mg on a solid catalyst basis. As a result, 240 g of an ethylene-1-butene copolymer was obtained. Further, this copolymer had an MFR of 2.1 g/10 min and thus had unsatisfactory molecular weight, and the amount of hydrogen evolved per g of the ethylene copolymer was as large as 0.018 mmol.

### COMPARATIVE EXAMPLE

(1) Synthesis of catalyst component and copolymerization of cthylene with 1-butene

A catalyst component was synthesized in the same manner as in Example 1, except that bis(cyclopentadienyl)zirconium dichloride was used instead of bis(2-methyltetrahydroindenyl)zirconium dichloride in the step (4) of Example t. Ethylene was then copolymerized with 1-butene in the same manner as in the step (5) of Example 1, except that the amount of the catalyst component used in the polymerization was changed to 15.0 mg on a solid catalyst basis. As a result, 170 g of an ethylene- 1-butene copolymer was obtained. This copolymer had an MFR of 1.3 g/ 10 min and thus had unsatisfactory molecular weight, and the amount of hydrogen evolved per g of the ethylene copolymer was as large as 0.016 mmol.

(1) Synthesis of catalyst component and copolymeization of ethylene with 1-butene

A catalyst component was synthesized in the same manner as in Example 1, except that (2-methylindenyl)cyclopentadienylzirconium dichloride was used instead of bis(2-methyltetrahydroindenyl)zirconium dichloride in the step (4) of Example 1. Ethylene was then copolymerized with 1-butene in the same manner as in the step (5) of Example 1, except that the amount of the catalyst component used in the polymerization was changed to 15.0 mg on a solid catalyst basis. As a result, the amount of the ethylene-1-butene copolymer thus obtained was as small as 75 g, indicating that the catalyst had low activity. Further, for this copolymer, the MFR was 0.11 g/10 min, and the amount of hydrogen evolved per g of the ethylene copolymer was 0.010 mmol.

### COMPARATIVE EXAMPLE 10

(1) Synthesis of catalyst component and copolymerization of ethylene with 1-butene

A catalyst component was synthesized in the same manner as in Example 1, except that (1,3-dimethylcyclopentadienyl)indenylzirconium dichloride was used instead of bis(2-methyltetrahydroindenyl)zirconium dichloride in the step (4) of Example 1. Ethylene was then copolymeried with 1-butene in the same manner as in the step (5) of Example 1, except that the amount of the catalyst component used in the polymerization was changed to 15.0 mg on a solid catalyst basis. As a result, the amount of the ethylene-1-butene copolymer thus obtained was as small as 20 g, indicating that the catalyst had low activity. Further, for this copolymer, the MFR was 0.05 g/10 min, and the amount of hydrogen evolved per g of the ethylene copolymer was 0.013 mmol.

Mw/Mn referred to in the following examples was determined using values measured by GPC. Specifically, values measured by GPC were converted to the number average molecular weight Mn and the weight average molecular weight Mw using standard polystyrene having known molecular weight by the Universal method, followed by determination of Mw/Mn. In the measurement, ISOC-ARC/GPC manufactured by Waters was used, and three columns of AD8OM/S manufactured by Showa Denko K. K. were used. The sample was dissolved in o-dichlorobenzene to prepare a 0.2 wt % solution. The chromatography was carried out using 200 μ of this solution under conditions of temperature 140° C. and flow rate 1 ml/min.

### EXAMPLE 5

(1) [Synthesis of bis(2-methyl-tetrahydroindenyl)zirconium dichloride]

Bis(2-methyl-tetrahydroindenyl)zirconium dichloride was synthesized in the same manner as described in Example 1 of Japanese Patent Application No. 295497/ 1997.

(2) [Preparation of catalyst]

A 200 ml flask provided with a strer was purged with nitrogen. Thereafter, 2.0 g of MAO on SiO₂ manufactured by WITCO (17.0 mmol-Al) was placed in the flask, and 50.0 ml of toluene was added thereto. 20.0 mL of a complex solution prepared by dissolving 68.6 mg of bis(2-methyltetrahydroindenyl)zirconium dichloride as a metalocene complex in toluene was added to the slurry with stirring at room temperature. The system was stirred for 10 min, and heptane was added thereto to a total solvent amount of 200 mL. Thus, a slurry catalyst was prepared.

(3) [Polymerization]

A 1.0-L stainless steel autoclave, which had been previously predried at 10° C. for 30 min while passage of nitrogen, was charged at room temperature with 500 mL of heptane, 30 mL of 1-hexene, and 8.0 mL (corresponding to 80 mg in terms of MAO on SiO₂) of the slurry catalyst prepared in the step (1) just above. Thereafter, the temperature and the pressure of ethylene were increased respectively to 65° C. and 7.0 kgf/cm²-G, and the temperature and the pressure within the polymertion tank were stabilized. Further, a solution of triethylaluminum in heptane was added in an amount of 57 mg in terms of triethylaluminum. Polymctrizaion was cared out for 1.5 hr while maintaining the total pressure at 7.0 kgf/cm²-G. After the completion of the polymerizationa, the reaction system was cooled, and ethylene was purged from the system, The resultant polyethylene slurry was then withdrawn and filtered. The polymer thus obtained was dried at 100° C. for 12 hr. Thus, 21.2 g of an ethylene/1-hexene copolymer was obtained. The results are shown in Table 1.

### COMPARATIVE EXAMPLE 11

The preparation of a catalyst, polymerization and pot treatment were careed out in the same manner as in Example 5, except that 64.7 mg of bis(n-butylcyclopentadienyl)zirconium dichloridc was used instead of bis(2-methyltetrahydroindenyl)zirconium dichloride. Thus, 37.1 g of a polymer was obtained. The results are shown ib Table 1.

### EXAMPLE 6

The preparation of a catalyst, polymerization and post treatment were carried out in the same manner as in Example 5, except that 77.6 mg of bis(2,4dimethyltetrahydroazulenyl)zirconium dichloride was used instead of bis(2-methyl-etrahydoindenyl)zirconium dichloride. Thus, 8.2 g of a polymer was obtained. The results are shown in Table 1.

### EXAMPLE 7

The preparation of a catalyst, polymerization and post treatment were carried out in the same manner as in Example 5, except that 64.1 mg of (octahydrofluorenyl)cyclopentadienylzirconiium dichloride was used instead of bis(2-meltyl-tetrahydroindenyl)zirconium dichloride. Thus, 20.5 g of a polymer was obtained. The results are shown in Table 1.

TABLE 1

| | Yield, g | Mw, × 10⁻⁴ | Mw/Mn |
|---|---|---|---|
| Example 5 | 21.2 | 14.80 | 2.47 |
| Example 6 | 8.2 | 15.92 | 2.40 |
| Example 7 | 20.5 | 13.15 | 2.33 |
| Comparative | | | |
| Example 11 | 37.1 | 8.49 | 2.56 |

What is claimed is:

1. A catalyst for the polymerization of ethylene, comprising the following components and in combination:
a metallocene type transition metal compound represented by the following formula or wherein R¹, R², R³, R⁴, R⁵, and R⁶, which may be the same or different, each independently represent a hydrogen atom, a halogen atom, a hydrogen carbon group having 1 to 20 carbon atoms, a halogen-containing hydrocarbon group having 1 to 20 carbon atoms, a silicon-containing hydrocarbon group, a nitrogen-containing hydrocarbon group, a phosphorus-containing hydrocarbon group, or a boron-containing hydrocarbon group, an alkoxy group, an aryl group, an aryloxy group, or an amino group; M represents a metal atom selected from group 4 to 6 elements of the periodic table; X and Y represent a hydrogen atom, a halogen atom, a hydroarbon group, an alkoxy group, an amino group, an amido group, a phosphorus-containing hydrocarbon group, or a silicon-containing hydrocarbon group; A represents a ligand selected from a cyclopentadienyl group, a substituted cyclopentadienyl group, an indenyl group, a substituted indenyl group, a fluorenyl group, a substituted fluorenyl group, an azulenyl group, and a substituted azulenyl group; a and c are an integer of 2 to 10; and b and d are an integer of 0 to 10, provided that, if b or d is 0, carbon atoms represented by C* are each independently linked to a hydrogen atom, a halogen atom, or to a hydrocarbon group having 1 to 20 carbon atoms, a halogen-containing hydrocarbon group, a silicon-containing hydrocarbon group, a nitrogen-containing hydrocarbon group, a phosphorus-containing hydrocarbon group, a boron-containing hydrocarbon group, an alkoxy group, an aryl group, or an aryloxy group, provided that atoms or groups linked to the respective carbon atoms may be the same or different; and
the following compound (a), (b), (c), or (d)
(a) an aluminumoxy compound,
(b) a Lewis acid,
(c) an ionic compound which can be reacted with the component to convert the component to a cation, or
(d) an ion-exchangeable layered inorganic compound.

2. The catalyst for the polymerization of ethylene according to claim 1, wherein the component is a metallocene type metal compound containing at least a tetrahydroindenyl derivative having a substituent at the 2-positon, a hexahydroazulenyl derivative having a substituent at the 2-position, or an octahydrofluorenyl derivative.

3. The catalyst for the polymerization of ethylene according to claim 1, wherein the component is an ionic-exchangeable layered inorganic compound (d).

4. The catalyst for the polymerization of ethylene according to claim 1, wherein the aluminumoxy compound (a) is a compound represented by the formula or:
wherein p is a number of 0 to 40 and R¹⁰ represents a hydrogen atom or a hydrocarbon residue.

5. The catalyst for the polymerization of ethylene according to claim 1, wherein the ionic compound (c), which can be reacted with the component convert the component to a cation, is a compound represented by the formula
[K]^{e+}[Z]^{e-} (6)
wherein K represents an ionic cation omponent selected from carbonium, tropylium, ammonium, oxonium, sulfonium, and phosphonium cations, cations of metals which as such are likely to be reduced, and cations of organometals; Z represents an anionic component which is a counter anion against a cation species converted from the component and is selected from organoboron compound, organoaluminum compound, organogallium compound, organophosphorus compound, organoarsenic compound, and organoantimony compound anions.

6. The catalyst for the polymerization of ethylene according to claim 15, which further comprises an organoalumininum compound as component.

7. The catalyst for the polymerization of ethylene according to claim 6, wherein the component is a compound represented by the formula
A1R¹¹ₘX_{3—m}
wherein R¹¹ represents a hydrocarbon radical having 1 to 20 carbon atoms; X represents a hydrogen atom, a halogen atom, an alkoxy group, a siloxy group, or an amido group; and m is an integer of 0<m<3.

8. A catalyst for the polymerization of ethylene, comprising the catalyst for the polymerization of ethylene according to claim 15, wherein the component is any one of the compounds (a) to (c), in combination with the following component:
an organic or inorganic particulate porous carrier.

9. A process for producing an ethylene polymer, comprising the step of polymerizing ethylene or ethylene and an α-olefin having 4 to 20 carbon atoms in the presence of the catalyst for the polymerization of ethylene according to claim 1 or 8.
